(19) United States
(12) Patent Application Publication
(10) Pub. No.: US 2008/0110507 A1
(43) Pub. Date: May 15, 2008

(54) BACKFLOW PREVENTION DEVICE FOR IN-LINE SCREW-TYPE INJECTION MOLDING MACHINE

(75) Inventors: Akira Yoshinaga, Numazu-shi (JP); Shigehiro Saito, Numazu-shi (JP); Haruyuki Matsubayashi, Numazu-shi (JP); Keisuke Mori, Numazu-shi (JP); Jun Koike, Numazu-shi (JP)

Correspondence Address: DLA PIPER US LLP, P. O. BOX 9271, RESTON, VA, 20195, US

(73) Assignee: TOSHIBA KIKAI KABUSHIKI KAISHA, CHIYODA-KU (JP)

(21) Appl. No.: 11/938,939

(22) Filed: Nov. 13, 2007

(30) Foreign Application Priority Data
Nov. 14, 2006 (JP) 2006-308208

(51) Int. Cl. F16K 15/08

(52) U.S. Cl. 137/528

(57) ABSTRACT

A check ring is mounted around a shaft of a screw tip that is mounted on a front part of a screw, whereby a resin is prevented from flowing back from ahead of a conical portion toward the screw. Projections are provided on a front end surface of the check ring. In measurement, a rear end surface of the conical portion of the screw tip and respective end surfaces of the projections are brought into contact with one another, whereby gaps are created between the screw tip and respective root surfaces of teeth of the check ring. By doing this, resin passages can be secured around contact surfaces between the rear end surface of the screw tip and the respective end surfaces of the projections of the check ring.

### CROSS-REFERENCE TO RELATED APPLICATIONS

This application is based upon and claims the benefit of priority from prior Japanese Patent Application No. 2006-308208, filed Nov. 14, 2006, the entire contents of which are incorporated herein by reference.

### BACKGROUND OF THE INVENTION

1. Field of the Invention

The present invention relates to a backflow prevention device for preventing a backflow of a resin from the front of a screw tip in an in-line screw-type injection molding machine.

2. Description of the Related Art

In general, an in-line screw-type injection molding machine uses an injection apparatus in which a screw is incorporated in a heating barrel (cylinder). When the injection molding machine, is driven, the screw is rotated in a forward direction in the heating barrel. As this is done, a material resin is introduced from a hopper into the heating barrel and moved forward by the screw. The material resin is stirred and heated in the heating barrel as it is melted and is fed forward beyond the screw. Thereupon, the screw is gradually retreated under the pressure of the molten resin and the resin is stored on the distal end side of the heating barrel (measurement process). After a predetermined amount of the molten resin is stored in the heating barrel, the screw is advanced to charge the resin into a die (charging process).

The injection apparatus of this type is generally provided with a backflow prevention device between the screw and a screw tip that is attached to a head portion at the distal end of the screw. In an example of the backflow prevention device, a check ring is mounted around a shaft that connects the screw and the screw tip on the head portion at the distal end of the screw. When the screw is rotated in the forward direction to feed the resin forward, the rear end surface of the check ring leaves the front end portion of the screw. Thereupon, a resin passage is connected in which the resin is fed forward through a gap between the check ring and the shaft from around the screw.

When the screw is advanced, moreover, the rear end surface of the check ring strikes the front end portion of the screw. Thereupon, the resin passage is closed. With this arrangement, some of the measured resin can be prevented from flowing back from ahead of the screw tip toward the screw when it is injected.

Another example of the backflow prevention device is described in Jpn. Pat. Appln. KOKAI Publication No. 2005-169899 (Patent Document 1). In the backflow prevention device of Patent Document 1, a plurality of projecting teeth are provided on the front end surface of a check ring. Further, the rear end surface of the screw tip is provided with recesses that engage the teeth, individually. That side surface of each tooth which is pressed against each corresponding recess when the screw is rotated in the forward direction is inclined so that the width of the tooth gradually narrows toward its distal end. The opposite side surface of the tooth is formed perpendicular to the front end surface of the check ring.

Correspondingly, that side surface of each recess of the screw tip against which each corresponding tooth is pressed when the screw is rotated in the forward direction is inclined at the same angle as the tooth so that the width of the recess gradually narrows toward the bottom. The opposite side surface of the recess is formed perpendicular to the rear end surface of the screw tip.

According to the backflow prevention device constructed in this manner, surface pressure in regions where the teeth and the recesses engage one another is lowered to enhance the mechanical strength of the device. In the measurement process, moreover, the check ring is pushed back toward the screw by a component of force that is generated by the inclination of the teeth and moves in the direction to close the gap between the ring and the front end portion of the screw. Thus, the resin passage can be quickly closed in an injection process of the next stage.

### BRIEF SUMMARY OF THE INVENTION

According to Patent Document 1, the respective root surfaces of the teeth of the check ring are in contact with the rear end surface of the screw tip without gaps during the measurement process in which the screw is rotated to feed the resin forward. In this state, the resin passage is restricted only to gaps between the teeth of the check ring and the recesses of the screw tip. Thus, the resin passage is so narrow that the measurement is unstable. In consequence, molded products may possibly be varied in quality and weight.

The present invention has been made in consideration of these circumstances, and its object is to provide a backflow prevention device for an in-line screw-type injection molding machine, capable of stabilizing measurement in a measurement process, thereby preventing variation in quality and weight of molded products.

A backflow prevention device for an in-line screw-type injection molding machine according to an aspect of the invention comprises a screw incorporated in a cylinder of a heating barrel, a screw tip disposed on a head portion at a distal end of the screw, and a check ring mounted for movement in an axial direction of the screw around a shaft which connects the screw tip and the screw, and configured so that a resin passage in which a resin is fed forward through a gap between the check ring and the shaft from around the screw is connected as a rear end surface of the check ring leaves a front end portion of the screw When the screw is rotated in a forward direction to feed the resin forward, and the resin passage is closed to prevent the resin from flowing back from ahead of the screw tip toward the screw as the rear end surface of the check ring strikes the front end portion of the screw when the screw is advanced, the check ring having a plurality of projecting teeth on a front end surface thereof, the screw tip having a plurality of recesses in a rear end surface thereof which engage the teeth, individually, each of the teeth having a first side surface which is pressed against each corresponding recess when the screw is rotated in the forward direction and a second side surface on the side opposite from the first side surface, the first side surface including a vertical surface perpendicular to the front end surface of the check ring, the second side surface including an inclined surface inclined so that the width of the tooth gradually narrows toward a distal end thereof, each of the recesses having a third side surface against which each corresponding tooth is pressed when the screw is rotated in the forward direction and a fourth side surface on the side opposite from the third side surface, the third side surface including a vertical surface perpendicular to the rear end surface of the screw tip, the fourth side surface including an inclined surface inclined at the same angle as the inclined surface of the tooth, the check ring including projections which secure a resin passage at the roots of the teeth, and the rear end surface of the screw tip and respective end surfaces of the projections being configured to come into contact with one another during measurement, thereby creating gaps which secure resin passages around contact surfaces between the rear end surface of the screw tip and the respective end surfaces of the projections.

When the screw is rotated in the forward direction to feed the resin forward during the operation of the in-line screw-type injection molding machine arranged in this manner, the rear end surface of the check ring leaves the front end portion of the screw, whereupon the resin passage in which the resin is fed forward through a gap between the check ring and the shaft from around the screw is connected. When the screw is advanced, the rear end surface of the check ring strikes the front end portion of the screw, whereupon the resin passage is closed to prevent the resin from flowing back from ahead of the screw tip toward the screw. If the screw is slightly rotated in a reverse direction after the measurement process is finished, moreover, the inclined side surface of each tooth is pressed against the inclined side surface of its corresponding recess. Thereupon, the inclined side surface of the tooth slides along the inclined side surface of the recess, and the check ring retreats relatively to the screw tip. As this is done, the rear end surface of the check ring strikes the front end portion of the screw, whereupon the resin passage is closed. Thus, it is possible to securely prevent a phenomenon that the resin passage of the backflow prevention device opens during suck-back operation after completion of the measurement process. In measurement, moreover, the rear end surface of the screw tip and the respective end surfaces of the projections of the check ring are brought into contact with one another, whereby the gaps are created between the screw tip and the respective root surfaces of the teeth of the check ring. By doing this, the resin passages are secured around the contact surfaces between the rear end surface of the screw tip and the respective end surfaces of the projections of the check ring. Thus, the measurement in the measurement process can be stabilized, so that variation in quality and weight of molded products can be prevented.

Preferably, each of the recesses is provided with a stepped portion in the middle of the fourth side surface and configured so that the rear end surface of the check ring comes into contact with the front end portion of the screw at the same time when the distal end of each of the teeth is in contact with the stepped portion.

When the distal end of each tooth is in contact with the stepped portion of the inclined side surface of each corresponding recess, in the above-described configuration, the position of the rear end surface of the check ring is regulated so that it comes into contact with the front end portion of the screw at the same time. Thus, when the screw is rotated in the reverse direction, the resin passage inside the check ring can be closed securely.

Preferably, the screw tip includes beveled portions in those regions in which the respective end surfaces of the projections are in contact with a rear end portion of the screw tip, the beveled portions serving to widen the gaps between the cylinder and the screw tip, and the respective end surfaces of the projections come into contact with the rear end portion of the screw tip, thereby blocking up the resin passages, so that the gaps between the cylinder and the screw tip are widened correspondingly to facilitate a flow.

When the rear end surface of the screw tip is brought into contact with the respective end surfaces of the projections during measurement, in the above-described configuration., the gaps between the cylinder in which the screw is inserted and the screw tip can be widened by the beveled portions in the regions where the respective end surfaces of the projections are in contact with the rear end portion of the screw tip. Thus, the respective end surfaces of the projections come into contact with the rear end portion of the screw tip, thereby blocking up the resin passages, so that the gaps between the cylinder and the screw tip can be widened correspondingly to facilitate a flow.

According to the backflow prevention device for the in-line screw-type injection molding machine of the invention, the measurement in the measurement process can be stabilized, so that variation in quality and weight of molded products can be prevented.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a side view showing a principal part of an example of a backflow prevention device for an in-line screw-type injection molding machine according to a first embodiment of the invention;

FIG. 2 is a side view showing a screw head portion of the injection molding machine of the first embodiment;

FIG. 3 is a side view showing a state of the screw head portion of the injection molding machine of the first embodiment during measurement;

FIG. 4 is a profile showing a principal part of a resin passage at the screw head portion of the injection molding machine of the first embodiment;

FIG. 5 is a side view showing a screw tip of the injection molding machine of the first embodiment;

FIG. 6 is a side view showing a recess in the screw tip of the injection molding machine of the first embodiment;

FIG. 7 is a front view showing the screw tip of the injection molding machine of the first embodiment;

FIG. 8 is a side view showing a check ring of the injection molding machine of the first embodiment;

FIG. 9 is a profile showing the check ring of the injection molding machine of the first embodiment;

FIG. 10 is a front view showing the check ring of the injection molding machine of the first embodiment;

FIG. 11 is a side view showing a pre-injected state of the screw head portion of the injection molding machine of the first embodiment; and

FIG. 12 is a side view showing a state in which a distal end portion of a tooth of the ring is in contact with a stepped portion of the recess of a screw of the injection molding machine of the first embodiment after the screw is rotated reversely.

### DETAILED DESCRIPTION OF THE INVENTION

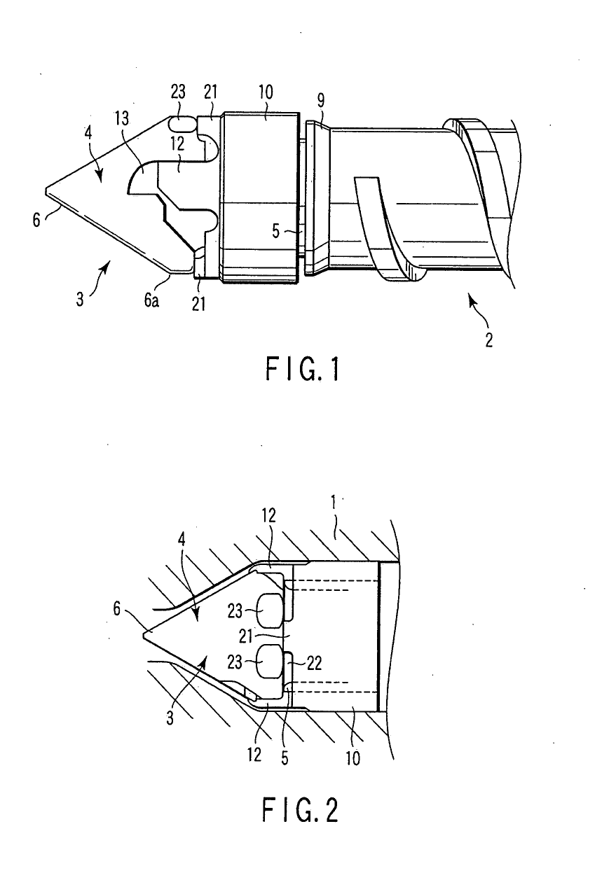

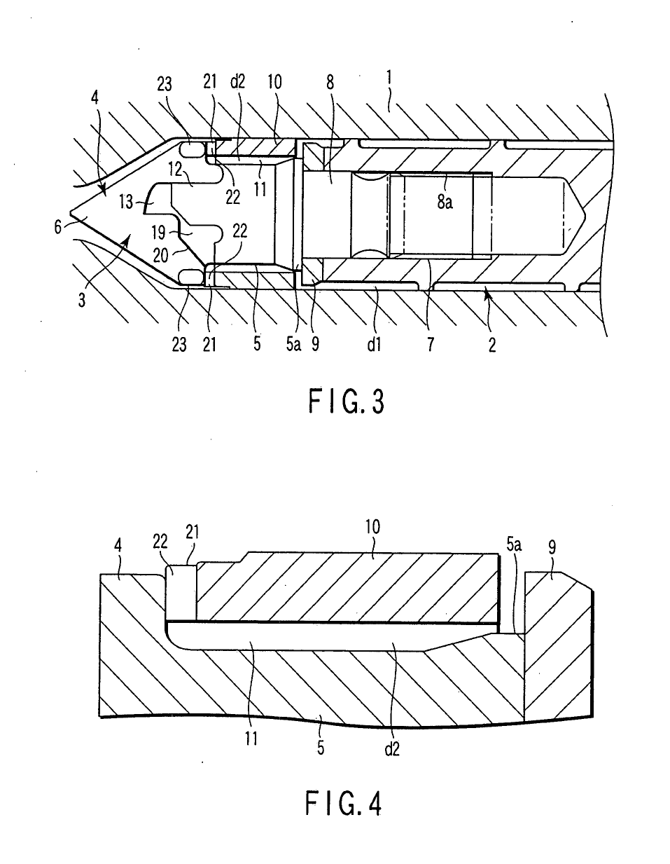

A first embodiment of the present invention will now be described with reference to the accompanying drawings. FIG. 1 shows an example of a backflow prevention device for an in-line screw-type injection molding machine according to the present embodiment. A screw 2 is incorporated in a cylinder 1 (see FIGS. 2 and 3) of a heating barrel of the injection molding machine.

A screw tip 4 is disposed on a screw head portion 3 at the distal end of the screw 2. As shown in FIGS. 5, 6 and 7, the screw tip 4 includes a shaft 5 and a tapered conical portion 6. The conical portion 6 is formed on the distal end portion of the shaft 5. The outside diameter of the shaft 5 is smaller than that of a maximum outside diameter portion 6a at the proximal end of the conical portion 6. The shaft 5 is formed having an intermediate projecting portion 5a that is larger in diameter than the other parts. A male screw portion 7 is formed on the proximal end portion of the shaft 5.

At the distal end portion of the screw 2, as shown in FIG. 3, a bore portion 8 extends in its axial direction. A female screw portion 8a is formed on the bottom side of the bore portion 8. Further, a ring-shaped spacer 9 is attached to the distal end surface of the screw 2.

In connecting the screw tip 4 and the screw 2, the shaft 5 of the screw tip 4 is inserted into the bore portion 8 of the screw 2. Then, the male screw portion 7 of the screw tip 4 is threadedly fitted to the female screw portion 8a of the screw 2, as shown in FIG. 3. As this is done, the screw tip 4 is fixed to the distal end of the screw 2 in a position such that the rear end of the intermediate projecting portion 5a of the shaft 5 abuts the spacer 9.

A cylindrical check ring 10 is mounted around the shaft 5 of the screw tip 4. The check ring 10 is located between the conical portion 6 and the intermediate projecting portion 5a. It functions as the backflow prevention device. The inside diameter of the ring 10 is larger than the outside diameter of the shaft 5 of the screw tip 4. A sufficient gap 11 is defined between the inner peripheral surface of the check ring 10 and the outer peripheral surface of the shaft 5 of the screw tip 4. The gap 11 has a size such that it can function as a resin passage.

Defined between the maximum outside diameter portion 6a at the proximal end portion of the conical portion 6 of the screw tip 4 and the spacer 9 of the screw 2 is a space in which the check ring 10 can move in the axial direction of the screw 2. If the screw 2 is rotated in a forward direction to feed a resin forward, the rear end surface of the ring 10 leaves the spacer 9 at the front end portion of the screw 2. Thereupon, resin passage d1 around that part of the screw 2 which is situated behind the spacer 9 connects with resin passage d2 corresponding to the gap 11. Accordingly, the resin can be fed forward through resin passage d1 around the screw 2 and resin passage d2 in the gap 11 between the ring 10 and the shaft 5.

If the screw 2 is advanced, on the other hand, the rear end surface of the check ring 10 strikes the spacer 9 at the front end portion of the screw 2. Thereupon, resin passage d2 in the gap 11 between the ring 10 and the shaft 5 can be disconnected from resin passage d1 around the screw 2.

As shown in FIG. 1, moreover, the front end surface of the check ring 10 is provided with a plurality (two in the present embodiment) of projecting teeth 12 that project forward. The rear end surface of the conical portion 6 of the screw tip 4 is provided with a plurality (two in the present embodiment) of recesses 13. The two teeth 12 are located in positions that are separated by 180° along the circumference of the front end surface of the check ring 10.

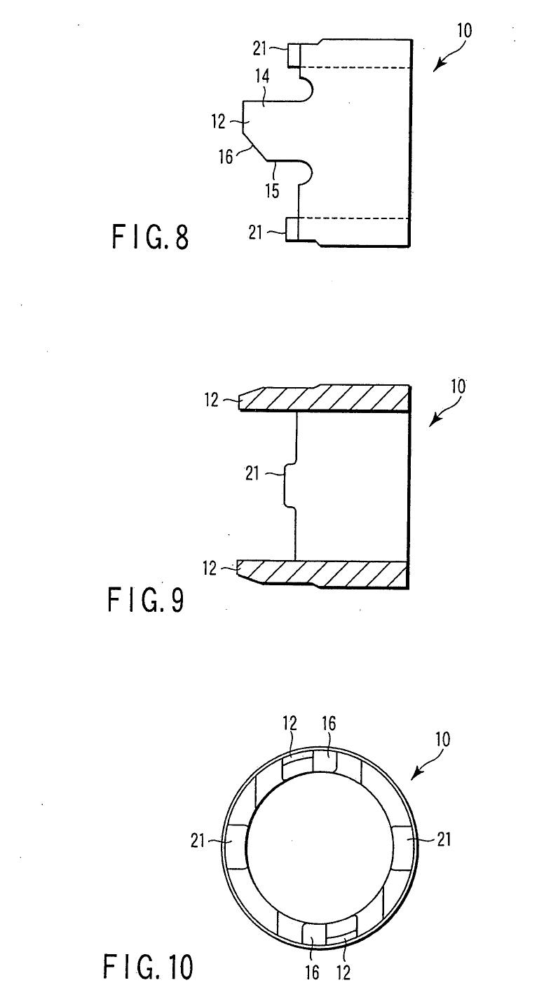

As shown in FIG. 8, each tooth 12 has two side surfaces (first and second side surfaces 14 and 15). The first side surface 14 is a side surface (upper side surface in FIG. 8) that is pressed against each corresponding recess 13 when the screw 2 is rotated in the forward direction. The first side surface 14 is formed perpendicular to the front end surface of the check ring 10. The second side surface 15 is a side surface (lower side surface in FIG. 8) opposite from the first side surface 14. An inclined surface 16 is formed on the distal end side of the second side surface 15. The inclined surface 16 is inclined so that the width of each tooth 12 gradually narrows toward the distal end thereof.

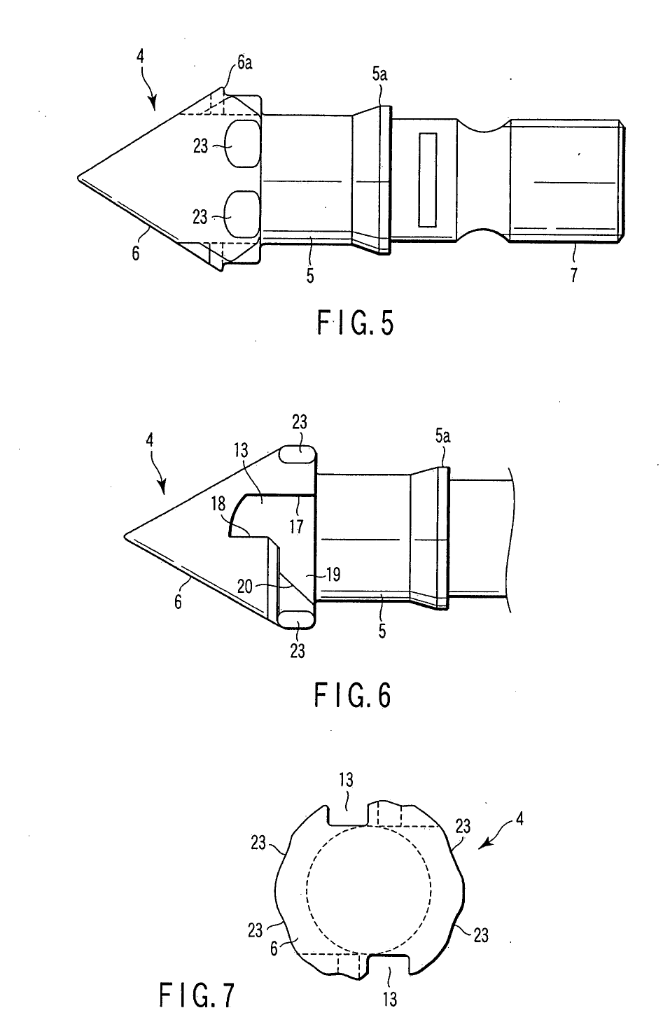

As shown in FIGS. 6 and 7, moreover, the screw tip 4 is formed with the two recesses 13 that releasably engage their corresponding teeth 12 of the check ring 10. The two recesses 13 are located in positions that are separated by 180° along the circumference of the screw tip 4. Each recess 13 has two side surfaces (first and second side surfaces 17 and 18) that correspond individually to the two side surfaces (first and second side surfaces 14 and 15) of each tooth 12. The first side surface 17 is a side surface (upper side surface in FIG. 6) against which the first side surface 14 of each tooth 12 is pressed when the screw 2 is rotated in the forward direction. The first side surface 17 is formed perpendicular to the rear end surface of the conical portion 6 of the screw tip 4. The second side surface 18 is a side surface (lower side surface in FIG. 6) opposite from the first side surface 17. Each recess 13 of the screw tip 4 is provided with a stepped portion 19 in the middle of the second side surface 18.

An inclined surface 20 is formed on a side surface of the stepped portion 19. The inclined surface 20 is inclined so that the width of each recess 13 gradually narrows toward the bottom. The inclined surface 20 of the stepped portion 19 is inclined at the same angle as the inclined surface 16 of each tooth 12.

FIG. 12 shows a state in which the distal end of one of the teeth 12 of the check ring 10 is in contact with the stepped portion 19 of the screw tip 4. In this state, the rear end surface of the check ring 10 is in contact with the front end portion of the spacer 9 of the screw 2.

As shown in FIG. 8, two projections 21 protrude forward from the front end surface of the check ring 10. They serve to secure a resin passage at the roots of the teeth 12 during measurement. As shown in FIG. 10, these projections 21 are located individually in substantially middle positions between the two teeth 12 along the circumferential direction of the front end surface of the check ring 10.

In measurement, the rear end surface of the conical portion 6 of the screw tip 4 is brought into contact with the respective end surfaces of the projections 21 of the check ring 10, as shown in FIGS. 3 and 4. Thus, gaps 22 are created between the conical portion 6 of the screw tip 4 and the respective root surfaces of the teeth 12 of the check ring 10.

Further, beveled portions 23 are formed on the rear end portion of the conical portion 6 of the screw tip 4. The beveled portions 23 are located in those regions in which the respective end surfaces of the projections 21 of the check ring 10 are in contact with the rear end portion of the conical portion 6. The beveled portions 23 serve to widen the gaps 22 between the cylinder 1 in which the screw 2 is inserted and the conical portion 6 of the screw tip 4.

When the rear end surface of the conical portion 6 of the screw tip 4 is brought into contact with the respective end surfaces of the projections 21 of the check ring 10 during measurement, the gaps 22 between the cylinder 1 in which the screw 2 is inserted and the screw tip 4 can be widened by the beveled portions 23 in the regions:where the respective end surfaces of the projections 21 are in contact with the rear end portion of the conical portion 6 of the screw tip 4.

The following is a description of the operation of the present embodiment arranged in this manner. In driving the in-line screw-type injection molding machine, the screw 2 is rotated in the forward direction to feed the resin forward (state of a measurement process). In this state, the rear end surface of the check ring 10 leaves the spacer 9 at the front end portion of the screw 2, as shown in FIG. 1. Thereupon, resin passage d1 around that part of the screw 2 which is situated behind the spacer 9 connects with resin passage d2 corresponding to the gap 11, as shown in FIG. 3. Accordingly, the resin is fed forward through resin passage d1 around the screw 2 and resin passage d2 in the gap 11 between the ring 10 and the shaft 5.

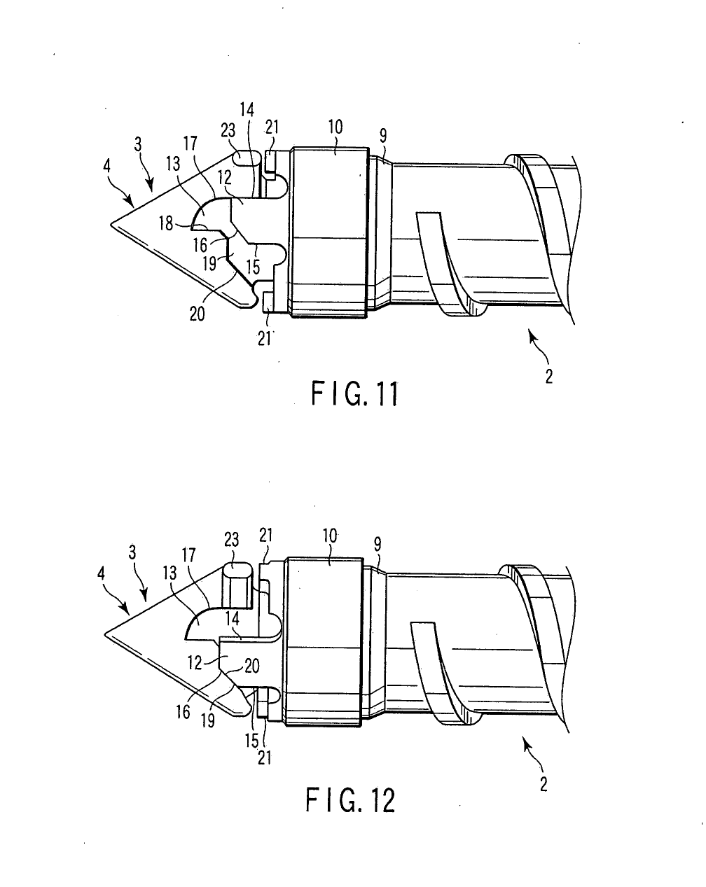

When the screw 2 is advanced, moreover, the rear end surface of the check ring 10 strikes the spacer 9 at the front end portion of the screw 2, as shown in FIG. 11. Thereupon, resin passage d2 in the gap 11 between the ring 10 and the shaft 5 is disconnected from resin passage d1 around the screw 2. Thus, the resin is prevented from flowing back from ahead of the conical portion 6 of the screw tip 4 toward the screw 2.

After the measurement process is finished, moreover, the screw 2 is slightly rotated in a reverse direction. By this operation, the inclined surface 16 of the second side surface 15 of each tooth 12 is pressed against the inclined side surface 20 of its corresponding recess 13, as shown in FIG. 12. Thereupon, the inclined surface 16 slides along the inclined surface 20, and the check ring 10 retreats relatively to the inclined surface 16 of the screw tip 4. Then, the rear end surface of the ring 10 strikes the spacer 9 at the front end portion of the screw 2. Thereupon, resin passage d2 in the gap 11 between the ring 10 and the shaft 5 is disconnected from resin passage d1 around the screw 2. Thus, it is possible to securely prevent a phenomenon that the resin passages of the backflow prevention device open during suck-back operation after completion of the measurement process.

When the distal end of each tooth 12 of the check ring 10 is in contact with the stepped portion 19, as shown in FIG. 12, moreover, the position of the rear end surface of the ring 10 is regulated so that it comes into contact with the front end portion of the spacer 9 of the screw 2 at the same time. Thus, when the screw 2 is rotated in the reverse direction, resin passage d2 in the gap 11 inside the check ring 10 can be closed securely.

During the measurement, furthermore, the rear end surface of the conical portion 6 of the screw tip 4 is brought into contact with the respective end surfaces of the projections 21 of the check ring 10, as shown in FIGS. 1 to 4. When this is done, the gaps 22 can be created between the screw tip 4 and the respective root surfaces of the teeth 12 of the ring 10. Accordingly, the resin passages can be secured around contact surfaces between the rear end surface of the screw tip 4 and the respective end surfaces of the projections 21 of the ring 10. Thus, the measurement can be stabilized, so that molded products can be prevented from being varied in quality and weight.

When the rear end surface of the conical portion 6 of the screw tip 4 is brought into contact with the respective end surfaces of the projections 21 of the check ring 10 during measurement, moreover the gaps 22 between the cylinder 1 in which the screw 2 is inserted and the screw tip 4 can be widened by the beveled portions 23. Thus, the respective end surfaces of the projections 21 come into contact with the rear end portion of the conical portion 6 of the screw tip 4, thereby blocking up the resin passages. Correspondingly, the gaps between the cylinder 1 and the screw tip 4 can be widened to facilitate the flow of the molten resin.

The above-described configuration produces the following effects. In the backflow prevention device for the in-line screw-type injection molding machine of the present embodiment, the check ring 10 is provided on its front end surface with the projections 21 that serve to secure the resin passage at the roots of the teeth 12 during measurement. In measurement, therefore, the gaps 22 can be created between the screw tip 4 and the respective root surfaces of the teeth 12 of the check ring 10 by bringing the rear end surface of the conical portion 6 of the tip 4 into contact with the respective end surfaces of the projections 21 of the ring 10. Thus, the resin passages can be secured around the contact surfaces between the rear end surface of the screw tip 4 and the respective end surfaces of the projections 21 of the ring 10. Thus, the measurement can be stabilized, so that molded products can be prevented from being varied in quality and weight.

In the present embodiment, moreover, the beveled portions 23 are provided in those regions in which the respective end surfaces of the projections 21 of the check ring 10 are in contact with the rear end surface of the conical portion 6 of the screw tip 4. When the rear end surface of the conical portion 6 is brought into contact with the end surfaces of the projections 21 during measurement, therefore, the gaps 22 between the cylinder 1 in which the screw 2 is inserted and the screw tip 4 can be widened by the beveled portions 23 in the regions where the end surfaces of the projections 21 are in contact with the rear end portion of the conical portion 6. Thus, the respective end surfaces of the projections 21 come into contact with the rear end portion of the conical portion 6 of the screw tip 4, thereby blocking up the resin passages. Correspondingly, the gaps between the cylinder 1 and the screw tip 4 can be widened to facilitate the flow of the molten resin.

It is to be understood, furthermore, that the present invention is not limited to the embodiment described above and that various changes and modifications may be effected therein without departing from the spirit of the invention.

The present invention is effective for a technical field in which a backflow prevention device is used to prevent a backflow of a resin from ahead of a screw tip toward a screw in an in-line screw-type injection molding machine and a technical field for manufacturing the backflow prevention device.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A backflow prevention device which comprises a screw incorporated in a cylinder of a heating barrel, a screw tip disposed on a head portion at a distal end of the screw, and a check ring mounted for movement in an axial direction of the screw around a shaft which connects the screw tip and the screw, and configured so that a resin passage in which a resin is fed forward through a gap between the check ring and the shaft from around the screw is connected as a rear end surface of the check ring leaves a front end portion of the screw when the screw is rotated in a forward direction to feed the resin forward, and the resin passage is closed to prevent the resin from flowing back from ahead of the screw tip toward the screw as the rear end surface of the check ring strikes the front end portion of the screw when the screw is advanced,
the check ring having a plurality of projecting teeth on a front end surface thereof,
the screw tip having a plurality of recesses in a rear end surface thereof which engage the teeth, individually,
each of the teeth having a first side surface which is pressed against each corresponding recess when the screw is rotated in the forward direction and a second side surface on the side opposite from the first side surface,
the first side surface including a vertical surface perpendicular to the front end surface of the check ring,
the second side surface including an inclined surface inclined so that the width of the tooth gradually narrows toward a distal end thereof,
each of the recesses having a third side surface against which each corresponding tooth is pressed when the screw is rotated in the forward direction and a fourth side surface on the side opposite from the third side surface,
the third side surface including a vertical surface perpendicular to the rear end surface of the screw tip,
the fourth side surface including an inclined surface inclined at the same angle as the inclined surface of the tooth,
the check ring including projections which secure a resin passage at the roots of the teeth, and
the rear end surface of the screw tip and respective end surfaces of the projections being configured to come into contact with one another during measurement, thereby creating gaps which secure resin passages around contact surfaces between the rear end surface of the screw tip and the respective end surfaces of the projections.

2. A device according to claim 1, wherein each said recess is provided with a stepped portion in the middle of the fourth side surface and configured so that the rear end surface of the check ring comes into contact with the front end portion of the screw at the same time when the distal end of each said tooth is in contact with the stepped portion.

3. A device according to claim 1, wherein the screw tip includes beveled portions in those regions in which the respective end surfaces of the projections are in contact with a rear end portion of the screw tip, the beveled portions serving to widen the gaps between the cylinder and the screw tip, and the respective end surfaces of the projections come into contact with the rear end portion of the screw tip, thereby blocking up the resin passages, so that the gaps between the cylinder and the screw tip are widened correspondingly to facilitate a flow.
